(19) United States
(12) Patent Application Publication
(10) Pub. No.: US 2014/0255602 A1
(43) Pub. Date: Sep. 11, 2014

(54) METHOD AND SYSTEM FOR FORMING A REFLECTIVE SURFACE

(71) Applicant: Aaron P. Bates, Elyria, OH (US)

(72) Inventor: Aaron P. Bates, Elyria, OH (US)

(21) Appl. No.: 14/000,392

(22) PCT Filed: Feb. 21, 2012
(86) PCT No.: PCT/US2012/025956

§ 371 Date: Aug. 19, 2013

Related U.S. Application Data
(60) Provisional application No. 61/444,474, filed on Feb. 18, 2011.

(51) Int. Cl. G02B 5/128; G02B 27/00

(52) U.S. Cl. CPC G02B 5/128; G02B 27/0006
USPC 427/163.4

(57) ABSTRACT

The method and system of the present invention involves coating a substrate or material with both a polymeric powder coating material and a retro-reflective material and finally applying a surface treatment of hydrophobic nano-molecular particles. The polymeric powder coating material provides a tough, corrosion resistant protective layer on the substrate and also acts as a binder in which the retro-reflective material is subsequently embedded.

### CROSS-REFERENCES

This application claims the benefit of provisional application Ser. No. 61/444,474, filed on Feb. 18, 2011.

### FIELD OF THE INVENTION

The present invention relates to a novel process for forming a hydrophobic, retro-reflective surface on a substrate. More particularly, the present invention relates to applying retro-reflective optical elements and a polymeric binder material to a substrate, then encapsulating the binder and element layer in a hydrophobic surface treatment to form a hydrophobic, retro-reflective surface coating on surfaces in need thereof such as highway products, guardrails, road markers, airport runways, or signs, bicycles, automobiles, mailboxes and the like.

### BACKGROUND OF THE INVENTION

Most highway products such as guardrails, guidance lines, such as centerlines, edge lines and lane markers depend upon some sort of light-reflecting device for making them more visible at night when the only source of illumination is the light from the motor vehicle head lamps. Such reflecting devices can be cube corners, glass microspheres, or simply light colored objects protruding above the pavement surface, all in the form of tape or liquid paints.

A plain white line painted on the surface or even a plain white plastic line adhered to the road surface is not easily visible even at a distance as near as 100 feet because of the extremely shallow angle of the light emanating from vehicle head lamps which impinge upon the road surface. Most of the incidental light is scattered and thus reflected away from the vehicle and very little returns by reflection for the operator to detect. Use of light-reflecting devices such as those mentioned above, incorporated within the painted or other light-colored line, can increase a motorists detection of the line out to many hundreds of feet. For example, the incorporation of transparent glass microspheres, ranging in size from a few thousandths of an inch in diameter to as much as a tenth of an inch, produce a better light reflection through an effect in which the microspheres serve as miniature optical lenses which focus the incident light from the headlamps into a tiny spot located a slight distance behind the rear surface of the microspheres. The focused spot of light falling upon a pigmented material after undergoing scattering is then partially reflected back upon itself and reaches the motorist's eyes by a phenomenon called retro-reflection. Because of light scattering by the pigmented binder in which the microspheres are partially embedded, only a small percentage of the incident light is returned by retro-reflection; but even this is considerably more light than is the case of an ordinary painted line. During daylight, the ordinary painted line is easily seen by a motorist for thousands of feet because of the abundance of ambient overhead skylight incident upon the line.

The principle of using glass microspheres as light-reflecting lenses for highway markers was disclosed as early as 1936 in U.S. Pat. No. 2,043,414. Soda-lime-silicate glass, such as window glass with a refractive index of 1.5, is commonly used as the medium for the microspheres because it is relatively inactive chemically and is a very hard material. This glass, forming the microspheres, generally causes the incident light to come to a focus some distance behind the rear surface of the microsphere. An increase in the brightness can result, however, when the light comes to a focus upon the rear surface of the microsphere itself. This occurs when a glass with a higher index of refraction is used. The distance behind the rear surface of a glass microsphere where the incident light comes to a focus is a function of the refractive index of the glass. As the refractive index increases from a value of approximately 1.5, the focus point moves in closer to the rear surface of the microsphere, reaching this surface when a refractive index value of approximately 1.9 is attained. At this point, the majority of the incident light is returned back upon itself in a retro-reflected beam.

If the rear surface of a microsphere is covered with a highly specular light-reflecting metal such as aluminum, chromium, silver or some other specular reflective material, then the entire incident light beam is returned except for small losses due to absorption and other minor effects, such as spherical aberration. Even without such a reflective coating, however, the returned light beam is considerably brighter than it would be with a lower refractive index glass. This effect is achieved because the scattered light in the focused spot is very near the rear surface of the sphere itself and thus most of it re-enters the sphere and produces a brilliant retro-reflected beam.

Certain known techniques for producing a retro-reflective surface on a substrate using reflective elements embedded in a binder utilize conventional coating techniques such as painting, laminating or dipping of the substrate in the binder. Such techniques are relatively expensive, inefficient and generate a large amount of waste and pollution. Further, these techniques utilized to achieve a retro-reflective surface create a surface that is not visible when wet. Typically, when a retro-reflective surface is wet, the visibility of the retro-reflective surface becomes greatly inhibited causing obvious problems to a coating/laminate that has a primary purpose of being visible in adverse outside conditions.

Electrostatic powder coating is a technique whereby an electrostatically charged particulate is adhered to an exposed surface of a neutrally charged object. This particulate can comprise any of a number of compounds, including a variety of thermoset and thermoplastic materials. The charged particles adhere to the surface of the object and are subsequently permanently bonded thereto by curing the powder coating using heat or some other method. The resulting coating provides exceptional toughness and impact resistance as well as resistance to environmental and chemical exposure. Fluidized bed powder coating is a technique in which powder particles are dispersed throughout a chamber by low pressure air or other gas. When a preheated substrate is introduced into the chamber, the particles strike the substrate where they melt and cling to its surface. Subsequent curing of the melted particles permanently bonds them to the substrate.

The use of powder coating techniques for coating and coloring the exposed surfaces of finished articles has increased in recent years, taking the place of traditional painting and dipping techniques. Powder coating techniques offer numerous advantages over conventional coating processes utilizing paint, lacquer or other solvent-based carriers.

A first, and perhaps the most important advantage, is the fact that powder coatings are applied without the use of solvents, thereby greatly reducing the amount of polluting volatile organic compounds released into the atmosphere. This allows the coating industry to meet ever increasingly strict environmental regulations and worker safety concerns easily and inexpensively. This aspect of powder coating, along with the fact that excess powder spray can be collected for reuse, also reduces the cost of disposal of potentially hazardous and flammable waste.

Thus, because powder coating provides many advantages over traditional coating techniques, a need exists for a method of producing hydrophobic retro-reflective surfaces on a substrate utilizing reflective elements in a powder coating process.

A prior patent which discloses application of a retro-reflective surface in conjunction with a powder coating process is disclosed in U.S. Pat. No. 6,623,793, the disclosure of which is incorporated herein by reference in its entirety. However, the process of the U.S. Pat. No. 6,623,793 does not function when wet and a modified process which involves fewer steps and a streamlined ability to achieve a water repellent retro-reflective coating that functions when wet is desirable.

### SUMMARY OF THE INVENTION

The process of the present invention involves coating a substrate or material with both a polymeric powder coating material and a retro-reflective material and finally applying a surface treatment of hydrophobic nano-molecular particles, such as those derived from Silanes, Silicones, Ti 02, fleurochemicals, or comparable particles thereto. The polymeric powder coating material provides a tough, corrosion resistant protective layer on the substrate and also acts as a binder in which the retro-reflective material is subsequently embedded. The process of the present invention includes the following steps:
1. Preparing a substrate for coating (pretreatment) (Optional);
2. Applying a polymeric coating material to the substrate, whether hot or cold;
3. Partially curing, e.g., heating, the polymeric material (Optional if polymeric material is applied in a molten state);
4. Apply retro-reflective material;
5. Finish curing the polymeric coating (Optional if the polymeric material is applied in a molten state; allowing retro-reflective elements to reach proper depth);
6. Apply clear coat (Optional);
7. Apply hydrophobic (or super hydrophobic) surface treatment to the entire surface that is now retro-reflective;
8. Dry hydrophobic surface treatment of step 7 via: air, forced air, or heat (infrared, conventional);
9. Apply self cleaning coating, e.g., an anti-organic Ti 02 based photo catalytic surface treatment (Optional if self cleaning/air purifying surface is desired).

Preparing the substrate for coating can be defined as a step that is utilized for typical preparation for powder coating a substrate. This can be, but is not limited to, cleaning, hanging, drying, preheating, blasting, sanding, grinding, conversion coating, vapor deposition, or degreasing, etc. using conventional methods.

The powder coating is applied to its surface by one of several methods, such as, but not limited to, electrostatic spray, fluidized bed treatment, extrusion or flame spraying. Any of the various known polymeric coatings can be used in the coating process according to the present invention. Typical polymeric materials usable in the coating process include, but are not limited to, epoxy compounds, polyesters, acrylics, polyester urethanes, acrylic epoxies and various hybrids and combinations thereof, as well as, typical thermoset and thermoplastic materials as well as olefin polymers, polyester polymers and ethylene acrylic acid based polymers. Partial curing of the polymeric coating, when required, is accomplished by conventional methods such as oven curing or curing with infrared radiation. This partially cured polymer acts as a binder in which reflective elements can be subsequently embedded. The partial curing step comprises approximately 35% of the total cure time or to the gel point of the polymer. Polymer can reach a molten state when applied to a pre-heated substrate as well.

After the polymeric coating is partially cured, or in the case of when a molten layer of polymeric material is applied, after application of the molten layer of polymeric material, a retro-reflective layer is applied to the substrate on top of the partially cured polymer or the molten polymer. The retro-reflective layer is comprised of a reflective material. Suitable reflective materials for the retro-reflective layer include glasses, ceramics, prismatics, metal flakes, plastics and other reflective materials known in the art. The reflective material can be in the form of small beads or chips, collectively known as reflective elements, and can be applied in any conventional manner, such as fluidized bed, roll application transfer process or sprayed on methods. Suitable reflective elements in the present invention include ceramic or glass beads or microspheres. Typical of these include beads made from soda-lime-silicate glasses (also known as barium titanate glass beads).

After the reflective material is applied to the powder-coated substrate, the powder is fully cured, if not applied in a molten state, to intimately bond the reflective material to the cured powder layer. Following the final cure step, the Si, Fluorine, or Ti 02 based hydrophobic nano-molecular surface treatment is then applied to provide a surface that maintains retro-reflectivity in wet conditions. The method of application can be, but is not limited to, spraying, dip/submerge, chemical vapor deposition, or wipe on methodology.

After the hydrophobic surface treatment has been applied a drying period must occur that may last from seconds to hours. The timing is dependent upon the available drying methods, heat, forced air, infrared radiation, etc.

As an optional final step, a photo catalytic nano-molecular Ti02 based surface treatment, e.g., a commercially available TiO2 nanopowder, can be applied to provide a self cleaning/air purifying/anti-fogging aspect to the now hydrophobic, retro-reflective coating surface.

### BRIEF DESCRIPTION OF DRAWINGS

The claimed subject matter is described with reference to the accompanying drawing. The accompanying drawing depicts multiple embodiments of the claimed system and method. A brief description of each figure is provided below. Elements with the same reference number in each figure indicate identical or functionally similar elements. Additionally, the left-most digit(s) of a reference number indicate the drawing in which the reference number first appears.

FIG. 1 is a flow chart of the process steps, including optional steps, of the present invention.

FIG. 2 is a representative cross-sectional, exploded view of an exemplary embodiment of the present invention, illustrating a single retro reflective element embedded in the polymeric coating.

### DETAILED DESCRIPTION OF THE INVENTION

In one embodiment of the present invention, a polymer process is disclosed in which a reflective material 210 is embedded in a polymeric binder coated on a substrate 202. The process is directed to the manufacture of high visibility road signs, using powder coating wherein the road sign is highly visible from an extreme distance and/or at night.

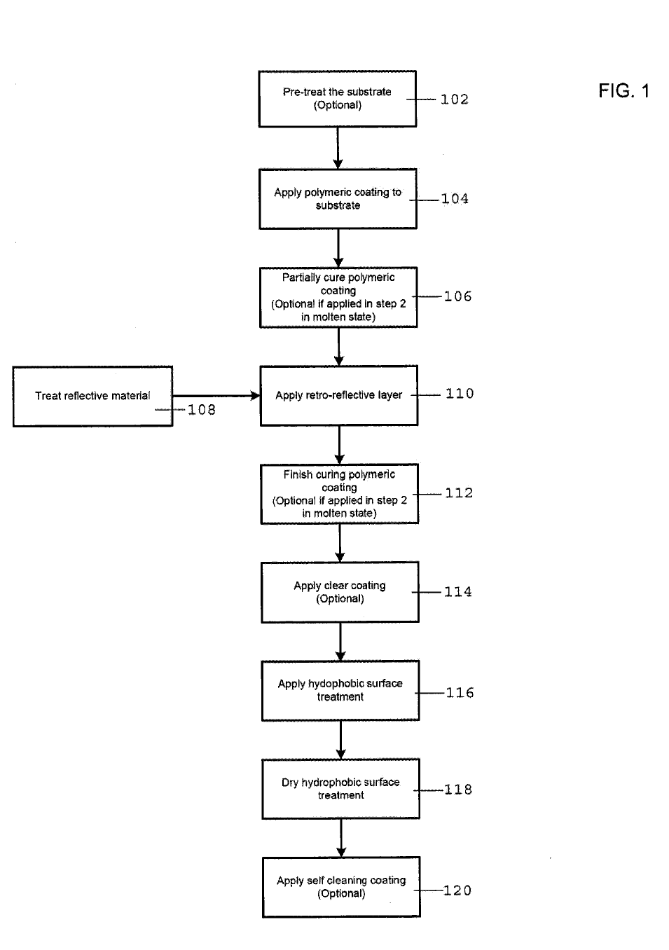

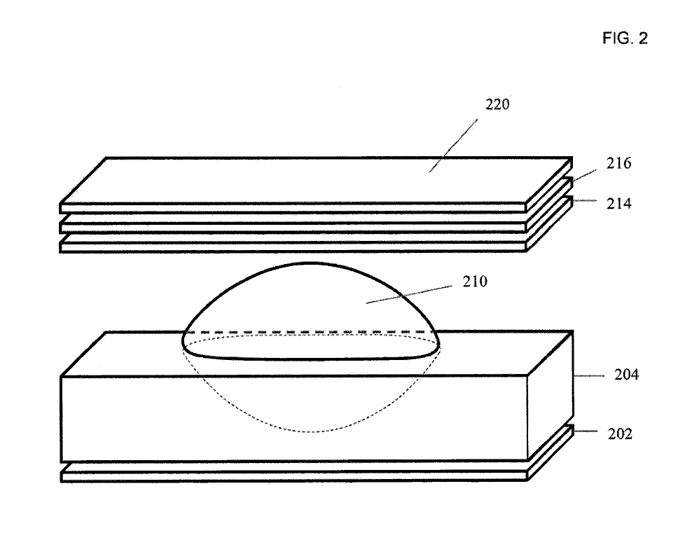

The present invention is described referring to FIG. 1 and FIG. 2 throughout. Due to the higher temperatures necessary to cure many traditional polymeric coatings, the substrate 202 is typically metal or some other material capable of withstanding elevated temperatures. Thus, for ease of discussion, the invention is described with the use of a metal substrate 202, but it should be understood not to be so limiting to the present invention such that the present invention is equally applicable to use with other substrates 202, e.g., wood, composite material, plastics, ceramics, etc. It is important to note, however, that certain polymeric coatings, including certain powder coatings that cure at somewhat lower temperatures, are now available, making the use of wood, plastic/polyermeric and other temperature sensitive materials as the substrate 202 practical.

According to a further aspect of the invention, the substrate 202 to be coated does not need to be treated in any special manner that is not currently utilized in the coating or painting industries as practical steps prior to application of the polymeric coating 204. In fact, certain pretreatment processes are detrimental to the adherence of the polymeric coating 204 and should be avoided. For example, pretreatment of galvanized steel will result in improper adherence of the polymer to the surface, and could potentially damage the zinc surface in ‘galvanized’ steel. In the event that a substrate 202 is pretreated, conventional methods are suitable. (See Step 102)

In accordance with the present invention, a substrate 202 is coated first with a polymeric material. (See Step 104) Different polymers may be used to coat the substrate 202, depending on the application, the substrate 202, and the final properties desired in the finished coated product. Any conventional polymeric coating 204 may be utilized in the present invention. These polymeric materials are available from various suppliers in assorted grades. Generally, for metal substrates 202, suitable polymeric coating 204 materials include thermoplastics, thermosets, and mixtures thereof. Particular examples of suitable materials can be readily selected by those skilled in the art. Thermoplastics, such as polyester, nylon, polyethylene, polypropylene and polyvinyl chloride, are compounds that melt and flow under the application of heat but do not undergo any chemical change. Thus, they can be cooled and re-melted numerous times. Although sometimes used in the polymeric coating 204 applications, thermoplastics are relatively expensive and tend to provide poor adhesion and protective properties compared to thermosets. For this reason, thermosets are a much more common type of polymeric coating.

Thermosets are compounds that will chemically crosslink (cure) under the application of heat. After cooling, thermosets will not re-melt when reheated once they are cured. Various types of thermosets may be used as the polymeric coating 204 in the present invention including, but not limited to, acrylics, epoxies, polyesters, polyurethanes and various hybrids and combinations thereof. Suitable acrylic compounds include hydroxyl functional acrylics and glycidyl methacrylate acrylics (GMA). Epoxies are among the most prevalent coatings, and in particular powder coatings, in the industry and exhibit good toughness and weather resistance. In addition, one or more different compounds can be combined to form a hybrid coating, often as mixtures of powders, which may exhibit some or all of the properties of the individual components. In this way, a formulator can tailor the coating to provide the exact properties desired. Due to their popularity and for ease of description, the invention will be described using a thermoset material as the coating. Therefore, mention will be made in subsequent steps of the curing of the powder. As described above, however, the invention contemplates the use of a thermoplastic material as the coating as well. In addition, the invention contemplates the application of the polymer as an extrusion or by flame spraying, thereby eliminating the need for partial, and possibly final, curing.

Added to the polymeric material can be a wide variety of other materials including, but not limited to, reinforcing fillers, extenders, pigments, processing aids, accelerators, cure agents, lubricants, coupling agents, plasticizers, preservatives, flow agents and other modifiers. These additional materials may be added in any concentration that does not adversely affect the properties of the polymeric coating 204 as a person of skill in the art would know.

There are several basic methods that may be used for applying the polymeric coating 204 material to the substrate 202. (See Step 104) The first application method is the use of an electrostatic spray. In this general method, polymeric powder is supplied through a delivery hose to a spray gun by air conveyance. The powder is electrostatically charged, either in the spray gun or at an electrode, and is deposited on a grounded substrate 202 by means of a static charge. There are two common charging processes that may be used in spray coating: corona charging and triboelectric charging.

Corona charging applies an electric charge (usually negative) to the powder as it exits the spray gun. A high voltage power supply creates a concentrated charge at an electrode positioned at the tip of a spray gun, creating an electric field which causes the adjacent air to ionize and generate a corona, creating negative ions. As the powder particles pass through the corona field, they are bombarded by the negative ions of the corona, which transfer their charge to the powder particles.

Triboelectric charging is a method in which static electricity is generated by the friction of the fast movement of the powder particles against materials that readily accept electrons. As the powder particles move down the barrel of the gun, they rub against the interior of the gun barrel and transfer electrons to it. The positively charged powder particles then exit the gun and adhere to the surface of the substrate 202.

As an alternative to spray coating, a polymeric coating 204 may be applied using a fluidized bed method. In this method, low pressure air or gas suspends the powder particles in a closed coating chamber, creating a cloud-like suspension of powder. When a preheated substrate 202 is introduced into the chamber, the powder strikes the substrate 202, melting and clinging to the substrate's 202 surface.

An additional method of applying the polymeric coating 204 includes heating the polymeric material to a molten state and then extruding the polymeric material and applying the extruded polymeric to the surface to be treated.

A further method of applying the molten polymeric material involved the use of flame spraying the polymeric material onto the surface to be treated. Flame spraying is a technique where a flame spraying device or “gun” is used to apply or “spray” on coating of molten polymeric material to a substrate 202.

The flame-spray technique was recently developed for application of thermoplastic powder coatings. The thermoplastic powder is fluidized by compressed air and fed into a flame gun where it is injected through a flame of propane, and the powder melts. The molten coating particles are deposited on the substrate 202, forming a film on solidification. Since no direct heating of the substrate 202 is required, this technique is suitable for applying coatings to most substrates 202. Metal, wood, rubber, and masonry can be successfully coated by this technique. This technology is also suitable for coating large or permanently-fixed objects.

The choice of powders is dependent on the end-use application and desired properties. Powders are typically individually formulated to meet specific finishing needs. Nevertheless, powder coatings fall into two basic categories: thermoplastic and thermosetting. The choice is application dependent. However, in general, thermoplastic powders are more suitable for thicker coatings, providing increased durability, while thermosetting powders are often used when comparatively thin coatings are desired, such as decorative coatings. The principal resins used in thermoplastic powders use primarily epoxy, polyester, and acrylic resins,

The concentration of powder in air must be controlled to maintain a safe working environment. Despite the absence of flammable solvents, any finely divided organic material, such as dust or powder, can form an explosive mixture in air. This is normally controlled by maintaining proper air velocity across face openings in the spray booth. In the dust collector, where the powder concentration cannot be maintained below the lower explosive limit, either a suppression system or a pressure relief device must be considered.

The thickness of the applied polymeric coating 204 can be controlled to provide the results desired based on the particular application intended for the finished product. A typical polymeric coating 204 thickness is from about 0.5 thousandths of an inch (0.5 mils) to about 50 mils. In spray coating techniques, including both powder coating and flame spraying, controlling the thickness of the powder coating can be accomplished by varying the rate of flow out of the spray gun as well as the distance between the gun and the substrate 202 to be coated. In fluidized bed coating techniques, the thickness of the powder is primarily controlled by varying the amount of time that the substrate 202 is left in the coating chamber, and the heat of the substrate 202 itself.

In the case of powder coating using the spray technique or the fluidized bed application, once the substrate 202 has been coated to the desired thickness, it is heated to above the melting temperature of the polymeric coating 204 in order to melt and, in the case of thermoset polymers, at least partially cure (See Step 106) the coating. This heating can be accomplished by any method that provides acceptable results, such as convection heating or infrared or ultraviolet radiation.

Convection heating uses hot air to transfer heat from the energy source to the article being heated. The most common convection systems use a gas flame and blower to provide circulation of heated air in an oven chamber. Other convection systems utilize electric infrared elements which, while cleaner, are generally more expensive to operate. In convection heating, the entire object including the substrate 202 must be brought to the cure temperature of the polymer. If the substrate 202 is large, it may take a substantial amount of time to fully heat, lengthening the time required to cure the polymeric coating 204. Since the entire oven chamber is heated evenly however, it is relatively easy to achieve consistent cure over the entire surface of even complex shaped objects.

Short wave, high-intensity infrared radiation provides a direct, radiant method of heating. Unlike convection heating, radiation heating does not require the medium to be heated for heat transfer to take place. Thus, since the air and substrate 202 do not need to be heated, substantial savings in cure time may be realized. However, a direct line between the surface to be heated and the radiator is necessary for optimum and consistent results. Substrates with complex shapes may heat unevenly, resulting in uneven cure in various locations on the substrate 202 surface. Radiation heating is best used with products of consistent and simple shape.

As stated previously, the polymeric coating 204 is heated such that it melts and flows together, forming a continuous film on the substrate 202 surface. The polymer is heated to such a degree that it partially cures (See Step 106), forming a viscous fluid film in which a reflective material 210 may be subsequently partially embedded. This partial curing is typically at the gel point of the polymer. The temperature and length of time necessary to achieve this partial cure will vary depending on the identity of the polymeric coating 204. Thus, for an acrylic urethane powder coating, the partial cure step might include heating the coating for about 15 minutes at about 375° F., however this partial curing is not needed if the polymeric coating 204 is in the molten state.

As the partially cured polymer coated substrate 202 exits from the heating chamber, and while it is still hot, a retro-reflective layer is applied to the surface of the substrate 202 on top of the partially cured polymer. (See Step 110) The retro-reflective layer comprises a reflective material 210. The polymeric coating 204 should be sufficiently tacky or gelled such that the reflective material 210 easily adheres thereto. The reflective material 210 can be applied in any manner such that it partially embeds in the partially cured polymer and bonds thereto. In one embodiment, the reflective material 210 is embedded in the partially cured polymer such that at least a part of the upper surface of the reflective material 210 is exposed to the atmosphere, thereby forming a retro-reflective layer and better permitting retro-reflection of incident light by the final product. And in a preferred embodiment, proper depth range is such that at least one half of the volume of most of the retro-reflective elements are embedded in the polymeric coating material.

When using flame coating or extrusion processes for application of the polymeric coating 204 to the substrate 202, the retro-reflective layer may be formed by application of the reflective material 210 to the coated substrate 202 immediately after application of the molten polymer so that the reflective material 210 partially embeds within the molten polymeric layer, resulting in the reflective material 210 to reach a desired depth within the molten polymer, wherein a person of skill in the art knows what depth would be proper based on the conditions of application and use to provide sufficient retro reflectivity and substantial security from dislodging.

Spherical glass microspheres that are retro-reflective by nature of their composition are the preferred reflective material 210 of the present invention. The spheres may be hemispherically coated with metal (metallized) so that they are more reflective, or may be uncoated. Various known reflective materials can be utilized in forming the retroreflective layer according to the process described herein. Reflective materials include, but are not limited to, glasses, ceramics, metals, plastics and other similar types of reflective materials known in the art. In one embodiment, the reflective material 210 comprises numerous distinct reflective optical elements. These optical elements are generally small grains or particles that act as lenses to diffract and reflect incident or direct light. (See Step 110)

The reflective optical elements can be any desired shape, such as triangular, square, pentagonal, hexagonal, etc. In one embodiment, the reflective elements are substantially spherical. Such spherical reflective elements are known in the art as microspheres.

A wide variety of ceramic optical elements (e.g. microsphere) may be employed in the present invention. Typically, for optimal retro-reflective effect, the optical elements have a refractive index of about 1.5 to about 2.6. Generally, optical elements of about 50 to about 1000 micrometers in diameter may be suitably employed. In one embodiment, the optical elements used have a relatively narrow size distribution for effective coating and optical efficiency.

The optical elements may comprise an amorphous phase, a crystalline phase, or a combination, as desired. Also, the optical elements may be comprised of inorganic materials that are not readily susceptible to abrasion. Suitable optical elements include microspheres formed of glass having indices of refraction of greater than about 1.5 and typically from about 1.5 to about 2.3. The optical elements most widely used are made of soda-lime-silicate glasses. Although the durability is acceptable, the refractive index is only about 1.5, which greatly limits their retro-reflective brightness. Higher-index glass optical elements of improved durability that can be used herein are taught in U.S. Pat. No. 4,367,919.

When glass elements are used, the fabrication of the retro-reflective layer occurs at temperatures below the softening temperature of the glass optical elements, so that the optical elements do not lose their shape or otherwise degrade. The optical elements' softening temperature, or the temperature at which the glass flows, generally should be greater than the process temperature used to form the retro-reflective layer. This is typically about 100° C. to about 200° C. above the process temperature used to form the retro-reflective layer.

The optical elements can be colored to match the binder (e.g. marking paints) in which they are embedded. Techniques to prepare colored ceramic optical elements that can be used herein are described in U.S. Pat. No. 4,564,556. Colorants such as ferric nitrate (for red or orange) may be added in the amount of about 1 to about 5 weight percent of the total metal oxide present. Color may also be imparted by the interaction of two colorless compounds under certain processing conditions (e.g., TiO₂ and ZrO₂ may interact to produce a yellow color). Further, a pigmented translucent layer on the reflective elements themselves may also be used to impart a color to the finished product.

Other materials may be included within the retro-reflective layer. These may be materials added to the optical elements during preparation, added to the optical elements by the supplier, and/or added to the retro-reflective layer during coating with the optical elements. Illustrative examples of such materials include pigments and skid-resistant particles.

Pigments may be added to the optical elements to produce a colored retro-reflective element. In particular, yellow may be desirable for yellow pavement markings. For example, praseodymium doped zircon ((Zr, Pr)SiO₄) and Fe₂O₃ or NiO in combination with TiO₂ may be added to provide a yellow color to better match aesthetically a yellow liquid pavement marking often used in centerlines. Cobalt zinc silicate ((Co, Zn)₂SiO₄) may be added to match a blue colored marking. Colored glazes or porcelain enamels may also be purchased commercially to impart color, for example yellow or blue.

Pigments which enhance the optical behavior may be added. For example, when neodymium oxide (Nd₂O₃) or neodymium titanate (Nd₂TiO₅) is added, the perceived color depends on the spectrum of the illuminating light.

Skid-resistant particles may be substituted for some of the optical elements. They are useful on retro-reflective and non-retroreflective pavement markings to reduce slipping by pedestrians, bicycles, and motor vehicles. The skid-resistant particles can be, for example, ceramics such as quartz, aluminum oxide, silicon carbide or other abrasive media. Preferred skid-resistant particles include fired ceramic spheroids having a high alumina content as taught in U.S. Pat. Nos. 4,937,127; 5,053,253; 5,094,902; and 5,124,178, the disclosures of which are incorporated herein by reference. Skid-resistant particles typically have sizes ranging from about 200 to about 800 micrometers.

Prior to applying the reflective material, e.g., spherical microspheres or beads, to the partially cured or molten layer of the polymeric coating 204, the microspheres are treated such that they repel the polymeric coating 204. The preferred method for treating the reflective material 210, e.g., microspheres, (See Step 108) is:
1. Break the carbon chain of the base chemistry of the microspheres using a solvent such as either isopropanol or mineral spirits. This is achieved by dissolving the base chemistry (in this case silane) into a solution of Isopropanol. The ratio of Isopropanol is within a range of 0.1 g to 1.5 g per 2100 g of microspheres. The range by weight of the base chemistry (silane) to be added to the isopropanol is weight by volume of 0.5 g to 5 g per 2100 g of microspheres.
2. Place the microspheres in a conventional mixing device;
3. Hydrate the microspheres with a predetermined amount of water; utilizing de-ionized water in a ratio of 0.1 g to 1.2 g per 2100 g of microspheres.
4. While the microspheres are being mixed, slowly add the silane solution coating that will cause the microspheres to repel from the polymeric coating 204. For example, depending on the type of polymeric coating 204 used on the substrate 202 (thermoset v. thermoplastic), the preferred chemical coating is a silane composition (derivative of silicon, Si) or a fluorochemical composition. (The preferred, fluorochemical solution is about 0.21 g to 4.0 g of Advanced Polymer APG—653 Fluorochemical and about 0.50 g of Mineral Spirits per 2000 g of microspheres.)
5. Mix the microspheres for about 15 minutes; and
6. Heat the microspheres at about 180 F for about 5-60 minutes. The desired thickness of the dry coating on the microspheres ranges from about 5 nanometers to about 50 microns.

The reflective material 210, i.e., microspheres or optical elements, are applied to the partially cured polymeric coating 204 or to the molten flame coated or extruded polymer by any effective means. A pneumatic or hydraulic powered dispensing machine can be used to deposit the optical elements on the polymeric coating 204. The optical elements should be deposited with such a velocity that the optical elements are partially embedded in the polymeric coating 204 with at least a portion of the surface of a sufficient number of optical elements still exposed to provide the desired retro-reflectivity to the finished article. Pressure may be applied to the optical elements after they have been deposited to assure that they are securely embedded in the polymeric coating 204.

Once the retro-reflective layer is deposited on the partially cured powder coating (See Step 110), the resulting assembly can then be heated to completely cure (See Step 112) the polymeric coating 204. In the case of thermoset polymers, this allows the thermoset to fully crosslink and reach is maximum toughness and durability. This finishing cure step also bonds the retroreflective layer to the cured polymeric coating 204, securing the two together more tightly and making the optical elements less likely to become dislodged. Again, the temperature and length of time necessary for final curing will depend on the identity and thickness of the polymeric coating 204. (See Step 112)

Optionally, an additional clear coating 214 may be applied after the coating is fully cured. This clear coating 214 may be added to provide protection for the retro-reflective layer and inhibit the dislocation of optical elements, or provide a coloration to the light as it reflects back to the source. This coating may comprise any clear material that does not unduly affect the retro-reflective properties of the product. (See Step 114)

After the retro-reflective, polymeric coated surface has been achieved, and finally cured (with or without the optional clear coat step) the coated surface is exposed to the atmosphere. This surface will have a surface tension that is such that water will ‘pool’ and collect in droplet form, thereby inhibiting vastly the ability of the surface to be viewable in the way that would be required of any retro-reflective surface. In order to treat the surface so that the newly formed retro-reflective, polymeric coated layer has a surface tension that is conducive to not only cause water to ‘sheet’ off of it, but to actually repel water away from itself; a hydrophobic surface treatment 216, e.g., nano-molecular, is now applied to the retro-reflective surface. (See Step 116)

Hydrophobicity is when hydrophobic molecules tend to be non-polar and thus prefer other neutral molecules and non-polar solvents. Superhydrophobic surfaces such as the leaves of the lotus plant have surfaces that are extremely difficult to wet. The contact angles of a water droplet exceeds 150° and the roll-off angle is less than 10°. This is referred to as the Lotus effect. The present invention requires that the surface of the retro-reflective polymeric coating 204 be hydrophobic, or preferably superhydrophobic; thereby increasing functional safety by allowing the retro-reflective surface to be reflective even when wet, or during wet conditions.

For this step, the now retro-reflective polymeric coated surface is coated with a hydrophobic/superhydrophobic chemical composition of nano-molecules (e.g., Si, silica, titania, Ti, fleurochemicals, and comparable compositions) in solvent suspension (e.g., water, ethanol, and the like). The method of coating is typically, but not limited to, by spray, though chemical, and vapor deposition, as well as by wipe-on methods.

In the preferred embodiment for applying a hydrophobic/superhydrophobic coating 216, the retro-reflective polymeric coated surface is treated by attaching a ‘nano’ film, i.e., to the protruding microspheres and polymer surface. The surface treatment is Si based and can consist of siloxane groups that terminate in a molecule that is either an ester, an ether or a halogen. The end molecule can be allowed, optionally, to react with water if desired to form an OH group. The surface can then optionally be exposed to a conventional capping agent (a strongly absorbed monolayer of organic molecules to aid stabilization of nanoparticles). This treatment of applying a hydrophobic/superhydrophobic coating 216 can be applied by conventional means, e.g., as a spray, wiped on, tank submerged or through deposition (vapor, or chemical).

Further, the hydrophobic/superhydrophobic Si based (siloxane derived) coating or surface treatment can be suspended in water, ethanol, isopropanol, alcohol, MEK (MEthyl, Ethyl Ketone), or other solvents. The method of suspension can vary depending on the environmental regulations of the region, e.g., state or country, in which the surface treatment will be applied. For example, the more flammable the solvent, the less likely it might be to be applied in Europe or California because of the strict regulations regarding flammable solvents in those regions. In such uses, water is added to the solution, thereby raising the flashpoint so that the suspension is less flammable and within the allowed tolerances of environmental regulations. Also, the method chemistry of the suspension can vary depending upon the method, and volume, of the application. For example, in spraying the coating in a high volume environment, e.g., commercial productions, the requirement for quick drying may be desired such that less water is utilized in the suspension.

The coating that is now retro-reflective and hydrophobic/superhydrophobic must now have a drying stage (See Step 118) that can last from seconds to hours depending upon the method of application, and the type of solvent used in suspension of the nano-particles. This drying time is that which a person of skill in the art would know based on the stated conditions.

After the powder coated, retro-reflective, hydrophobic/superhydrophobic surface has dried, an optional application of self cleaning photocatalytic 220 Ti (titania, Ti 02) can be applied to achieve a surface that is both self cleaning as well as able to clean the air of organic materials. This coating has been found to be useful in cutting down smog pollution in the air, as well as keeping the surface better able to stay clean so that it is visible and retro-reflective for extended periods of time. (See Step 120)

The end products for which the coating process can be utilized include any known product for which a reflective surface is desired. Such products include, but are not limited to, highway signs, roadside safety products, auto parts (cars, motorcycles, trucks, buses, etc.), bicycles, railroad cars, railroad signs and crossing gates, loading and freight dock markings, airport runways, parking lots and garages, mailboxes and virtually anywhere light delineation is needed.

Various modifications and alterations of this invention will become apparent to those skilled in the art without departing from the scope and spirit of this invention. It should be readily understood that this invention contemplates these modifications and is not to be unduly limited to the illustrative embodiments set forth herein.

### CONCLUSION

While various embodiments of the present invention have been described above, it should be understood that they have been presented by the way of example only, and not limitation. It will be understood by those skilled in the art that various changes in form and details may be made therein without departing from the spirit and scope of the invention as defined. Thus, the breadth and scope of the present invention should not be limited by any of the above-described exemplary embodiments.

What is claimed is:

1. A process for forming a retro-reflective surface on a substrate, comprising:
distributing a polymeric coating material on to the substrate;
embedding a plurality of retro-reflective elements in said polymeric coating material to a proper depth range, wherein said polymeric coating material is in a molten state; and
allowing said polymeric coating material to cool to form a retro-reflective surface on the substrate.

2. The process of claim 1, wherein the substrate is heated before said distribution of said polymeric coating material on to the substrate, wherein the substrate is heated to a temperature such that after said distribution of said polymeric coating material on to the substrate said polymeric coating material reaches a molten state.

3. The process of claim 1, wherein said polymeric coating material is heated to a molten state before said polymeric coating material is distributed on to the substrate.

4. The process of claim 1, wherein said proper depth range is such that said plurality of retro-reflective elements are substantially secure from dislodging while also being exposed enough to provide sufficient retro-reflectivity.

5. The process of claim 4, wherein said proper depth range is such that at least one half of the volume of a substantial number of said plurality of retro-reflective elements are embedded in said polymeric coating material.

6. The process of claim 1, wherein the substrate is pre-treated.

7. The process of claim 1, further comprising:
applying a clear coat surface treatment on said retro-reflective surface.

8. The process of claim 1, further comprising:
applying a hydrophobic surface treatment to said retro-reflective surface.

9. The process of claim 1, further comprising:
applying a self-cleaning surface treatment to said retro-reflective surface.

10. The process of claim 1, wherein said plurality of retro-reflective elements are a plurality of spherical glass microspheres.

11. The process of claim 10, wherein said plurality of spherical glass microspheres are hemispherically coated with a reflective metal.

12. The process of claim 1, wherein said plurality of retro-reflective elements have a refractive index of about 1.5 to about 2.6.

13. A process for forming a retro-reflective surface on a substrate comprising:
distributing a polymeric coating material on to the substrate; and
treating said plurality of retro-reflective elements such that said elements repel said polymeric coating, said treating comprising the steps of:
breaking a carbon chain of a base chemistry of said elements using a solvent, wherein this is achieved by dissolving said base chemistry into a base chemistry solution of said solvent, wherein a ratio of said solvent is within a range of about 0.1 g to about 1.5 g per 2100 g of said elements, wherein a range by weight of said base chemistry to be added to said solvent is weight by volume of about 0.5 g to about 5 g per 2100 g of said elements;
placing said elements in a conventional mixing device;
hydrating said elements with a predetermined amount of water in a ratio of about 0.1 g to about 1.2 g per 2100 g of said elements;
adding said base chemistry solution into said conventional mixing device
mixing for about 15 minutes resulting in a plurality of wet-coated elements; and
heating said wet-coated elements at about 180 degrees fahrenheit for about 5-60 minutes, resulting in a plurality of dry-coated elements with thicknesses in ranges from about 5 nanometers to about 50 microns.

14. The process of claim 13, further comprising:
embedding said plurality of dry-coated elements in said polymeric coating material to a proper depth range, wherein said polymeric coating material is in a penetrable state prepared for receiving said plurality of dry-coated elements; and
finishing said polymeric coating material to form a retro-reflective surface on the substrate.

15. A process for forming a hydrophobic retro-reflective surface on a substrate comprising:
distributing a polymeric coating material on to the substrate;
embedding a plurality of retro-reflective elements in said polymeric coating material to a proper depth range, wherein said polymeric coating material is partially cured and in a penetrable state prepared for receiving said plurality of retro-reflective elements; and
finishing curing of said polymeric coating material to form a retro-reflective surface on the substrate.

16. The process of claim 15, further comprising:
applying a hydrophobic surface treatment to said retro-reflective surface.

17. The process of claim 15, further comprising:
drying said hydrophobic surface treatment to form a hydrophobic retro-reflective surface on the substrate.

18. The process of claim 15, further comprising:
applying a self-cleaning surface treatment to said hydrophobic retro-reflective surface.

19. The process of claim 15, wherein said plurality of retro-reflective elements are a plurality of spherical glass microspheres.

20. The process of claim 17, wherein said plurality of spherical glass microspheres are hemispherically coated with a reflective metal.
